(19) United States
(12) Patent Application Publication
(10) Pub. No.: US 2012/0234007 A1
(43) Pub. Date: Sep. 20, 2012

(54) RANKINE CYCLE APPARATUS

(75) Inventors: Fuminobu ENOKIJIMA, Kariya-shi (JP); Masao Iguchi, Kariya-shi (JP); Hidefumi Mori, Kariya-shi (JP)

(73) Assignee: KABUSHIKI KAISHA TOYOTA JIDOSHOKKI, Kariya-shi (JP)

(21) Appl. No.: 13/417,761

(22) Filed: Mar. 12, 2012

(30) Foreign Application Priority Data
Mar. 15, 2011 (JP) 2011-056845
Aug. 29, 2011 (JP) 2011-186221

(51) Int. Cl. F02C 1/04

(52) U.S. Cl. 60/682

(57) ABSTRACT

A Rankine cycle apparatus includes a circuit having a pump for working fluid, a heat exchanger for causing heat exchange between the working fluid and fluid supplied from an exhaust heat source, and an expanding portion that expands the working fluid that has been exposed to the heat exchange to produce mechanical energy. The expanding portion includes a fixed scroll, a movable scroll that orbits with respect to the fixed scroll, and a back pressure chamber arranged at the side corresponding to a backside of the movable scroll opposite to the surface facing the fixed scroll. The Rankine cycle apparatus further includes an inlet mechanism for introducing the working fluid from a high pressure zone that extends from the outlet side of the pump to the inlet of the heat exchanger to the back pressure chamber to produce back pressure that presses the movable scroll against the fixed scroll.

### BACKGROUND OF THE INVENTION

The present invention relates to a Rankine cycle apparatus having a circuit including a pump for pumping a working fluid, a heat exchanger for causing heat exchange between the working fluid sent from the pump and fluid from an exhaust heat source, and an expanding portion that expands the working fluid that has been exposed to the heat exchange in the heat exchanger to produce mechanical energy.

A scroll type expanding portion used in a Rankine cycle apparatus includes a movable scroll, which orbits through rotation of a drive shaft, and a fixed scroll, which is fixed to a housing. A volute portion is formed on an end plate of the movable scroll. Another volute portion is arranged on an end plate of the fixed scroll. An expansion chamber is formed between the volute portions. After obtaining thermal energy in a heat exchanger, working fluid flows into the expansion chamber via a suction chamber of an expanding portion and expands in the expansion chamber. Such expansion causes orbiting motion of the movable scroll, thus producing mechanical energy (drive force).

To improve efficiency for producing mechanical energy through the scroll type expanding portion, it is important that the working fluid expand efficiently in the expansion chamber. It is thus important to prevent leakage of the working fluid from the expansion chamber, or, in other words, improve sealing performance of the expansion chamber. Japanese Laid-Open Patent Publication No. 10-184567 describes a technique for improving sealing performance of an expansion chamber in a scroll type expanding portion.

In the technique described in the publication, a back pressure chamber is formed at the side corresponding to the backside (the surface opposite to the surface facing a fixed scroll) of an end plate of a movable scroll. Pressure in the back pressure chamber is increased to apply back pressure onto the backside of the movable scroll. The back pressure presses the movable scroll against the fixed scroll in the axial direction of a drive shaft. As a result, the distal end of a volute portion of the movable scroll is pressed against an end plate of the fixed scroll, and an end plate of the movable scroll is pressed against the distal end of a volute portion of the fixed scroll. This enhances sealing performance of the expansion chamber.

However, according to the technique, the back pressure is produced by introducing some working fluid from the expansion chamber into the back pressure chamber via a gas passage. The thermal energy of the working fluid that has been sent into the back pressure chamber is thus not used to produce mechanical energy using the scroll type expanding portion. As a result, although the technique improves sealing performance of the expansion chamber in a Rankine cycle apparatus employing the scroll type expanding portion, loss is caused in conversion from thermal energy into mechanical energy. This decreases efficiency for outputting the mechanical energy.

### SUMMARY OF THE INVENTION

Accordingly, it is an objective of the present invention to provide a Rankine cycle apparatus that improves sealing performance of an expansion chamber by applying back pressure onto a movable scroll and prevents decrease of the efficiency for producing mechanical energy.

To achieve the foregoing objective and in accordance with one aspect of the present invention, a Rankine cycle apparatus having a circuit. The circuit includes a pump for pumping working fluid, a heat exchanger for causing heat exchange between the working fluid received from the pump and fluid supplied from an exhaust heat source, and an expanding portion that expands the working fluid that has been exposed to the heat exchange in the heat exchanger, thereby producing mechanical energy through the expansion. The expanding portion includes a fixed scroll, a movable scroll that orbits with respect to the fixed scroll as a drive shaft rotates, and a back pressure chamber arranged at the side corresponding to a backside of the movable scroll opposite to the surface facing the fixed scroll. The Rankine cycle apparatus further includes an inlet mechanism for introducing the working fluid from a high pressure zone to the back pressure chamber, thereby producing back pressure that presses the movable scroll against the fixed scroll along the axial direction of the drive shaft. The high pressure zone is a zone extending from an outlet side of the pump to an inlet of the heat exchanger.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a diagram illustrating a complex fluid machine and a Rankine cycle apparatus according to a first embodiment of the present invention;

FIG. 1B is an enlarged diagram showing the inlet passage illustrated in FIG. 1A;

FIG. 1C is an enlarged diagram showing the outlet passage illustrated in FIG. 1A;

FIG. 2 is a cross-sectional view taken along line 2-2 of FIG. 1A;

FIG. 3 is a diagram illustrating a complex fluid machine and a Rankine cycle apparatus according to a second embodiment of the invention;

FIG. 4 is a diagram illustrating a complex fluid machine and a Rankine cycle apparatus according to a third embodiment of the invention;

FIG. 5 is a diagram illustrating a complex fluid machine and a Rankine cycle apparatus according to a fourth embodiment of the invention;

FIG. 6A is an enlarged diagram showing the proximity of the inlet of an inlet passage illustrated in FIG. 5;

FIG. 6B is an enlarged diagram showing the proximity of the outlet of the inlet passage illustrated in FIG. 5;

FIG. 6C is a plan view showing a plate and a vaporizing passage illustrated in FIG. 5;

FIG. 7A is a diagram illustrating a complex fluid machine and a Rankine cycle apparatus according to a fifth embodiment of the invention;

FIG. 7B is an enlarged diagram showing the proximity of the outlet of an inlet passage illustrated in FIG. 7A; and

FIG. 7C is an enlarged diagram showing the proximity of the inlet of the inlet passage illustrated in FIG. 7A.

### DETAILED DESCRIPTION OF THE PREFERRED EMBODIMENTS

### First Embodiment

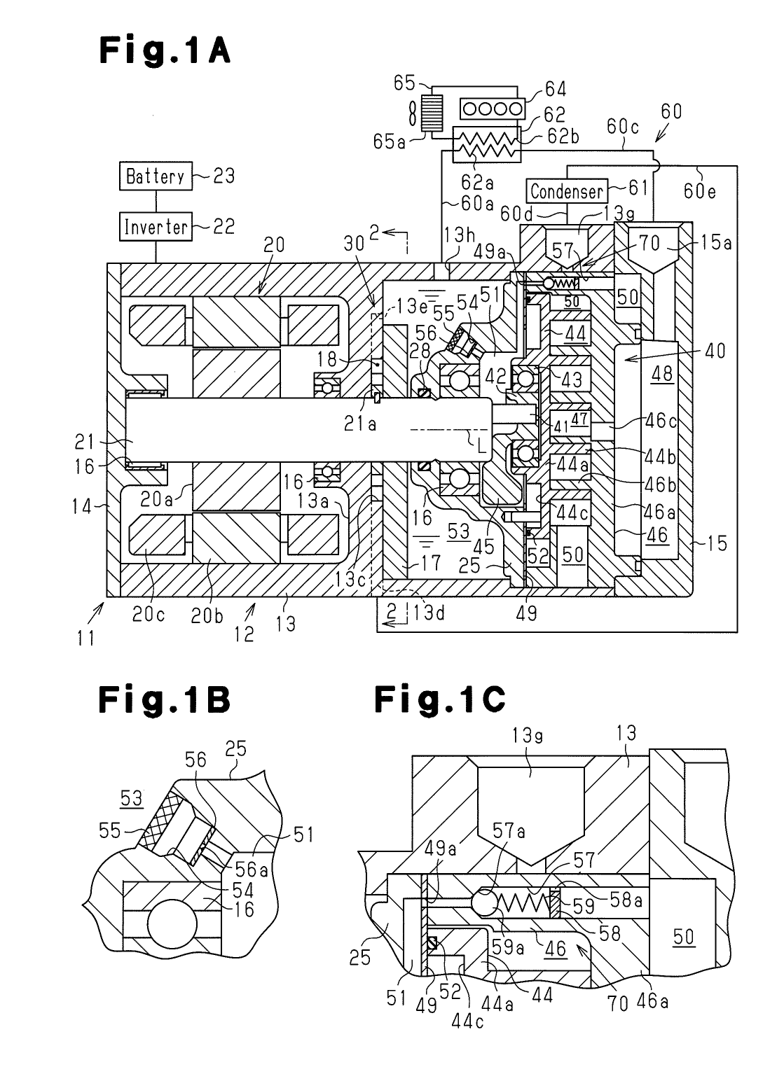

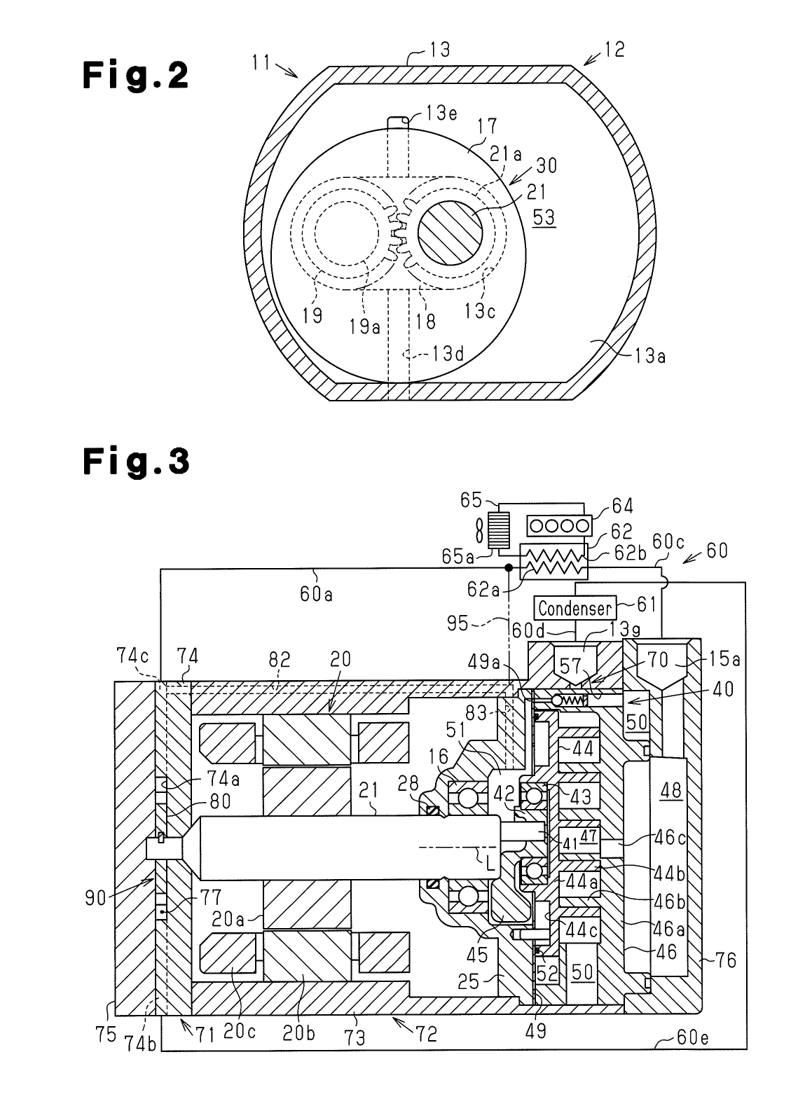

A first embodiment of the present invention will now be described with reference to FIGS. 1A to 1C and 2.

As shown in FIG. 1A, a housing 12 of a complex fluid machine 11 includes a tubular central housing member 13, a front housing member 14, and a rear housing member 15. A first end (the left side as viewed in FIG. 1A) of the central housing member 13 is joined to the front housing member 14. A second end (the right side as viewed in the drawing) is joined to the rear housing member 15. A partition wall 13a extends radially inward from the inner circumferential surface of the central housing member 13 to divide the interior of the housing 12 into two sections.

Of the two sections, the space defined by the partition wall 13a and the front housing member 14 accommodates a motor-generator 20 serving as a rotating electric machine. The space defined by the partition wall 13a and the rear housing member 15 receives a support block 25 and an expanding portion 40.

The motor-generator 20 includes a drive shaft 21, a motor-rotor 20a, which is fixed to the drive shaft 21 in an integrally rotational manner, and a stator 20b located around the motor-rotor 20a. The drive shaft 21 is supported by three bearings 16, which are each supported by the corresponding one of the front housing member 14, the partition wall 13a, and the support block 25. The stator 20b is fixed to the inner circumferential surface of the central housing member 13.

The motor-generator 20 is capable of functioning as a motor that rotates the motor-rotor 20a through electric current supplied to a coil 20c of the stator 20b and as a generator that generates electric power in the coil 20c of the stator 20b through rotation of the motor-rotor 20a. A battery 23 is connected to the motor-generator 20 through an inverter 22. The power produced by the motor-generator 20 is stored in the battery 23 through the inverter 22.

The surface (the right surface as viewed in FIG. 1A) of the partition wall 13a facing the rear housing member 15 has an oval recess 13c, which is arranged around the drive shaft 21. A side plate 17 is fixed to this surface to close the recess 13c. This forms a pump chamber 18 between the partition wall 13a and the side plate 17. As shown in FIG. 2, the pump chamber 18 accommodates a drive gear 21a, which is attached to the drive shaft 21, and a driven gear 19. A shaft portion 19a of the driven gear 19 is rotationally supported by the partition wall 13a and the side plate 17. The drive gear 21a and the driven gear 19 are meshed with each other. The pump chamber 18, the driven gear 19, and the drive gear 21a configure a gear pump 30.

The partition wall 13a has a suction passage 13d, which extends downward from the pump chamber 18. A first end of the suction passage 13d has an opening in the outer surface (the lower surface) of the central housing member 13. A second end of the suction passage 13d is connected to the pump chamber 18. The partition wall 13a also has a discharge passage 13e, which extends upward from the pump chamber 18. A first end of the discharge passage 13e is connected to the pump chamber 18. A second end of the discharge passage 13e is open in the space defined by the partition wall 13a and the rear housing member 15, which is located above the peripheral edge of the side plate 17.

With reference to FIGS. 1A to 1C, the support block 25 is fixed in the space defined by the partition wall 13a and the rear housing member 15, as has been described. The expanding portion 40, which is a scroll type, is arranged in the space defined by the support block 25 and the rear housing member 15. The drive shaft 21 extends through the support block 25. A shaft seal 28 formed by an O-ring is mounted in the inner circumferential surface of the support block 25. The shaft seal 28 seals the gap between the circumferential surface of the drive shaft 21 and the inner circumferential surface of the support block 25.

An eccentric shaft 41 is formed at the distal end of the drive shaft 21, which extends through the support block 25, and located at a position eccentric with respect to the axis L of the drive shaft 21. The eccentric shaft 41 revolves about the axis L as the drive shaft 21 rotates. A bushing 42 is fixed to the eccentric shaft 41 and revolves about the axis L integrally with the eccentric shaft 41. The bushing 42 supports a movable scroll 44 rotationally through a bearing 43. A counterweight 45 is fixed to the bushing 42.

The movable scroll 44 has a disk-shaped end plate 44a, which is supported by the bearing 43, and a volute portion 44b projecting from the end plate 44a. A fixed scroll 46 is fixed to the side of the support block 25 corresponding to the rear housing member 15 and faces the movable scroll 44. An annular plate 49 is arranged between the opposing end surfaces of the support block 25 and the fixed scroll 46.

The movable scroll 44 is arranged between the support block 25 and the fixed scroll 46 and orbits within the range corresponding to the plate 49 as viewed along the axis L (in the axial direction). A sealing member 52 formed by an O-ring is arranged in the end surface of the outer peripheral portion of the movable scroll 44 that faces the plate 49. The sealing member 52 thus seals the gap between the plate 49 and the movable scroll 44.

A back pressure chamber 51 is formed by the space defined by the portion of the movable scroll 44 radially inward of the sealing member 52 and the inner surface of the support block 25. The back pressure chamber 51 is air-tightly sealed by the sealing member 52 arranged in the movable scroll 44 and the shaft seal 28 formed in the support block 25. The surface of the movable scroll 44 opposite to the surface facing the fixed scroll 46 (the surface of the movable scroll 44 facing the support block 25), which is the surface exposed in the back pressure chamber 51, is a backside 44c of the movable scroll 44.

The fixed scroll 46 integrally includes a disk-shaped end plate 46a and a volute portion 46b projecting from the end plate 46a toward the movable scroll 44. The volute portion 44b of the movable scroll 44 and the volute portion 46b of the fixed scroll 46 are meshed with each other, thus forming an expansion chamber 47, which has a variable volume, between the movable scroll 44 and the fixed scroll 46.

A suction hole 46c is formed in a central portion of the end plate 46a of the fixed scroll 46. A suction chamber 48 is formed in the space defined by the end plate 46a and the rear housing member 15. The suction chamber 48 communicates with the expansion chamber 47 before expansion through the suction hole 46c. A suction port 15a, which communicates with the suction chamber 48, is formed in the rear housing member 15. A discharge chamber 50 is formed in the space defined by the inner circumferential surface of the fixed scroll 46 and the outermost circumferential surface of the volute portion 44b of the movable scroll 44 and in a section close to the outer periphery of the suction chamber 48. A discharge port 13g, which communicates with the discharge chamber 50, is formed in the central housing member 13.

The complex fluid machine 11 has a retaining portion 53, which is formed by an inner surface of the central housing member 13, the side plate 17, and the support block 25. The retaining portion 53 is formed in an annular shape around the drive shaft 21. The retaining portion 53 communicates with the pump chamber 18 through the discharge passage 13e, which is formed in the partition wall 13a. Accordingly, the high-pressure working fluid that has been pumped from the pump chamber 18 into the discharge passage 13e is sent into the retaining portion 53 via the discharge passage 13e. This raises the pressure in the retaining portion 53 compared to the pressure in the back pressure chamber 51. That is, the retaining portion 53 is a high pressure zone. A discharge hole 13h, which communicates with the retaining portion 53, is formed in an upper portion of the central housing member 13. The working fluid in the retaining portion 53 is introduced into a heat exchanger 62 in a Rankine cycle apparatus 60, which will be described later, through the discharge hole 13h.

The Rankine cycle apparatus 60, which incorporates the complex fluid machine 11, will now be described. As illustrated in FIG. 1A, the discharge hole 13h, which communicates with the retaining portion 53, is connected to a heat absorber 62a of the heat exchanger 62 through a first passage 60a. The heat exchanger 62 has a heat dissipater 62b, in addition to the heat absorber 62a. The heat dissipater 62b is arranged in a coolant circulation path 65, which is connected to the engine 64 serving as an exhaust heat source. A radiator 65a is formed in the coolant circulation path 65. Coolant water, which is fluid sent from the engine 64 serving as the discharge heat source, circulates in the coolant circulation path 65.

The outlet side of the heat absorber 62a of the heat exchanger 62 is connected to the suction port 15a of the expanding portion 40 through a second passage 60c. The discharge port 13g of the expanding portion 40 is connected to the condenser 61 through a third passage 60d. The outlet side of the condenser 61 is connected to the suction passage 13d of the gear pump 30 through a fourth passage 60e.

In the Rankine cycle apparatus 60, electric power is supplied from the battery 23 to the motor-generator 20 through the inverter 22 such that the motor-generator 20 is actuated as the motor, thus driving the gear pump 30. The gear pump 30 sends working fluid through the discharge passage 13e, the retaining portion 53, and the discharge hole 13h. The working fluid then enters the heat exchanger 62 via the first passage 60a. In the first embodiment, the discharge passage 13e, the retaining portion 53, and the discharge hole 13h configure a main passage, through which working fluid is sent from the gear pump 30 to the heat exchanger 62.

The heat exchanger 62 causes heat exchange between the heat absorber 62a and the heat dissipater 62b such that the working fluid is heated by exhaust heat from the engine 64 to receive thermal energy. The heated high temperature and high pressure working fluid flows through the second passage 60c and enters the expansion chamber 47 of the expanding portion 40 through the suction port 15a. The working fluid is thus expanded and causes the expanding portion 40 to produce mechanical energy (drive force). The drive force causes the movable scroll 44 to orbit. As the drive shaft 21 of the motor-generator 20 rotates, the gear pump 30 is actuated.

At this stage, if a great amount of exhaust heat has been supplied by the engine 64 and a great amount of mechanical energy is generated by the expanding portion 40, the drive shaft 21 rotates at a speed exceeding a predetermined speed. If this is the case, the motor-generator 20 functions as a generator to decrease the rotation speed of the drive shaft 21. Excess of the mechanical energy corresponding to the excessive rotation speed is converted into electric energy and charged in the battery 23 through the inverter 22.

The expanded working fluid, which is under reduced pressure and high temperature, is sent into the discharge chamber 50 and introduced into the third passage 60d through the discharge port 13g. The working fluid is then liquefied in the condenser 61 and sent from the suction passage 13d to the pump chamber 18 via the fourth passage 60e. The gear pump 30 is driven by the mechanical energy generated by the expanding portion 40, thus sending working fluid from the pump chamber 18 to the retaining portion 53 through the discharge passage 13e.

After the retaining portion 53 is filled with working fluid, overflowing working fluid flows into the first passage 60a through the discharge hole 13h and is sent to the heat exchanger 62 through the first passage 60a. Afterwards, the working fluid flows in the expanding portion 40, the condenser 61, and the gear pump 30, as has been described. As long as the engine 64 is in operation, the working fluid circulates in the circuit of the Rankine cycle apparatus 60.

Next, an inlet mechanism for introducing the working fluid pumped out by the gear pump 30 into the back pressure chamber 51 to press the movable scroll 44 against the fixed scroll 46 will be described.

As illustrated in FIGS. 1A and 1B, an inlet passage 54 serving as the inlet mechanism is formed in the support block 25. The inlet passage 54 introduces working fluid from the high pressure zone (the retaining portion 53) between the outlet side of the gear pump 30 and the inlet of the heat exchanger 62 to the back pressure chamber 51. The inlet passage 54 is branched from the main passage (the discharge passage 13e, the retaining portion 53, and the discharge hole 13h), through which working fluid is sent from the gear pump 30 to the heat exchanger 62.

A filter 55 is fixed to the opening end of the inlet passage 54 at the side corresponding to the retaining portion 53. The filter 55 removes foreign matter from the working fluid that is sent from the retaining portion 53 to the back pressure chamber 51. In the inlet passage 54, a restriction plate 56 is fixed at a position between the filter 55 and the back pressure chamber 51. The restriction plate 56 has a restriction hole 56a, which decreases (restricts) the diameter of the inlet passage 54.

With reference to FIG. 10, the fixed scroll 46 has an outlet passage 57, which is arranged at a position outward of the discharge chamber 50 located at the side corresponding to the outer periphery of the movable scroll 44. A first end of the outlet passage 57 is connected to the back pressure chamber 51 via a communication hole 49a, which is formed in the plate 49. A second end of the outlet passage 57 is connected to the discharge chamber 50 in the aforementioned section close to the outer periphery of the suction chamber 48. The discharge chamber 50 is a zone for receiving the low pressure working fluid, which has been expanded in the expansion chamber 47. As a result, the pressure in the discharge chamber 50 is lower than the pressure in the back pressure chamber 51. The discharge chamber 50 is thus a low pressure zone.

In the outlet passage 57, a valve seat 57a is configured by a step formed by increasing the diameter of the outlet passage 57 along the direction extending from the plate 49 toward the discharge chamber 50. A spring seat 58 is fixed in the outlet passage 57 and supports a first end of a coil spring 59, which is in a compressed state. An escape passage 58a is formed in the spring seat 58 and allows communication between the space on the side of the spring seat 58 facing the coil spring 59 and the on the side of the spring seat 58 facing the discharge chamber 50. A ball valve 59a is fixed to a second end of the coil spring 59. As the coil spring 59 extends or contracts, the ball valve 59a contacts or separates from the valve seat 57a.

The urging force of the coil spring 59 is set such that, when the pressure in the back pressure chamber 51 exceeds a predetermined value, the coil spring 59 contracts. As the ball valve 59a selectively contacts and separates from the valve seat 57a through operation of the coil spring 59, the pressure difference between the back pressure chamber 51 and the discharge chamber 50 is adjusted to a predetermined appropriate value. Specifically, if the pressure in the back pressure chamber 51 exceeds the predetermined value and the pressure difference between the back pressure chamber 51 and the discharge chamber 50 becomes higher than the predetermined appropriate value, the ball valve 59a separates from the valve seat 57a to decrease the pressure in the back pressure chamber 51, thus reducing the pressure difference. At this stage, the working fluid that has been sent from the back pressure chamber 51 to the outlet passage 57 is introduced into the discharge chamber 50 through the escape passage 58a.

In contrast, when the pressure in the back pressure chamber 51 drops below the predetermined value and the pressure difference becomes lower than the predetermined appropriate value correspondingly, the ball valve 59a is seated on the valve seat 57a to raise the pressure in the back pressure chamber 51, thus increasing the pressure difference. Accordingly, in the first embodiment, the valve seat 57a, the coil spring 59, the ball valve 59a, and the spring seat 58 configure an outlet side pressure difference adjustment mechanism 70.

Operation of the Rankine cycle apparatus 60 incorporating the complex fluid machine 11 will hereafter be described. In the Rankine cycle apparatus 60, the retaining portion 53 retains high pressure working fluid. The retaining portion 53 communicates with the back pressure chamber 51 via the inlet passage 54. The restriction hole 56a in the inlet passage 54 injects the working fluid from the retaining portion 53 into the back pressure chamber 51. In other words, the back pressure chamber 51 receives working fluid before the working fluid is sent to the heat exchanger 62, or, specifically, receives thermal energy from the heat exchanger 62.

As the high pressure working fluid is introduced into the back pressure chamber 51, back pressure is applied onto the backside 44c of the end plate 44a of the movable scroll 44. This axially presses the movable scroll 44 against the fixed scroll 46, thus pressing the end plate 44a of the movable scroll 44 against the distal end of the volute portion 46b of the fixed scroll 46 and the distal end of the volute portion 44b of the movable scroll 44 against the end plate 46a of the fixed scroll 46. This improves sealing performance of the expansion chamber 47 such that working fluid is prevented from leaking from the expansion chamber 47 and allowed to expand efficiently in the expansion chamber 47.

As working fluid flows into the back pressure chamber 51, the back pressure acting on the backside 44c varies. However, the pressure difference between the back pressure chamber 51 and the discharge chamber 50 is adjusted to the aforementioned appropriate value by the outlet side pressure difference adjustment mechanism 70. This adjusts the back pressure appropriately, thus stabilizing the force with which the movable scroll 44 is pressed against the fixed scroll 46.

The first embodiment has the advantages described below.

(1) The back pressure chamber 51 faces the backside 44c of the movable scroll 44 in the expanding portion 40. The back pressure chamber 51 receives working fluid from the high pressure zone between the outlet side of the gear pump 30 and the inlet of the heat exchanger 62. This increases the back pressure acting on the backside 44c, thus pressing the movable scroll 44 against the fixed scroll 46 to improve the sealing performance of the expansion chamber 47. Specifically, working fluid is introduced into the back pressure chamber 51 to generate the back pressure before the working fluid is sent to the heat exchanger 62 to receive thermal energy. The working fluid is not sent to the back pressure chamber 51 after having received the thermal energy in the heat exchanger 62. Accordingly, the thermal energy transmitted to the working fluid in the heat exchanger 62 is prevented from being consumed to produce the back pressure but converted into mechanical energy in the expanding portion 40. This prevents loss in conversion from thermal energy to mechanical energy, unlike a case in which working fluid having thermal energy is used to produce back pressure. As a result, even though the sealing performance of the expansion chamber 47 is enhanced through the back pressure, efficiency for generating mechanical energy is prevented from decreasing.

(2) The Rankine cycle apparatus 60 incorporates the complex fluid machine 11, which has the gear pump 30 and the expanding portion 40 accommodated in the housing 12. The inlet passage 54 is formed in the housing 12 and high pressure working fluid is sent into the back pressure chamber 51 through the inlet passage 54. This reduces the amount of piping compared to, for example, a case in which the gear pump 30 and the expanding portion 40 are arranged separately from each other and working fluid is introduced from the gear pump 30 to the back pressure chamber 51 through a pipe outside the housing 12. As a result, the space for installing the Rankine cycle apparatus 60 is reduced.

(3) The gear pump 30 and the expanding portion 40 are received in the housing 12 of the complex fluid machine 11, which is incorporated in the Rankine cycle apparatus 60. The gear pump 30 and the expanding portion 40 are arranged in parallel in the housing and adjacently located in the axial direction of the complex fluid machine 11. Accordingly, since the motor-generator 20 is not arranged between the gear pump 30 and the expanding portion 40, the distance between the gear pump 30 and the expanding portion 40 is shortened correspondingly, compared to a case in which the gear pump 30, the motor-generator 20, and the expanding portion 40 are arranged sequentially in that order in the axial direction of the complex fluid machine 11. This correspondingly decreases the length of the inlet passage 54, thus allowing working fluid to rapidly flow from the gear pump 30 to the back pressure chamber 51.

(4) The back pressure chamber 51 communicates with the discharge chamber 50, the pressure in which is lower than the pressure in the back pressure chamber 51, via the outlet passage 57. The valve seat 57a, the coil spring 59, the ball valve 59a, and the spring seat 58 are arranged in the outlet passage 57 as the outlet side pressure difference adjustment mechanism 70. Through selective contact and separation between the ball valve 59a and the valve seat 57a, the pressure difference between the back pressure chamber 51 and the discharge chamber 50 is adjusted to the appropriate value. This stabilizes the force by which the movable scroll 44 is pressed against the fixed scroll 46.

(5) The restriction plate 56 is arranged in the inlet passage 54 and the restriction hole 56a, which has a smaller diameter, is formed in the restriction plate 56. Working fluid is introduced from the high pressure zone between the outlet side of the gear pump 30 and the inlet of the heat exchanger 62 into the back pressure chamber 51 via the inlet passage 54. The filter 55 is arranged in the inlet passage 54. The filter 55 removes foreign matter from the working fluid, thus preventing the restriction hole 56a from being clogged by foreign matter.

(6) The housing 12 has the retaining portion 53 for retaining the working fluid that has been pumped out by the gear pump 30. The discharge hole 13h, through which the working fluid is sent from the retaining portion 53 to the heat exchanger 62, is formed in the housing 12. The retaining portion 53 forms a portion of the main passage through which working fluid flows from the gear pump 30 to the heat exchanger 62. The inlet passage 54, which is branched from the retaining portion 53 (the main passage), is formed in the support block 25 facing the retaining portion 53. The inlet passage 54 sends high pressure working fluid to the back pressure chamber 51. The filter 55 is arranged in the inlet passage 54. Specifically, the working fluid flows through the retaining portion 53 (the main passage) and reaches the heat exchanger 62. That is, most of the foreign matter contained in the working fluid is sent to the heat exchanger 62 by the flow of working fluid in the main passage. This substantially prevents the foreign matter from entering the inlet passage 54, thus allowing the filter 55 to have a small surface area. In other words, the filter 55 is reduced in size.

(7) The back pressure produced by the high pressure working fluid in the back pressure chamber 51 acts on the backside 44c of the movable scroll 44, thus pressing the movable scroll 44 against the fixed scroll 46. The outlet side pressure difference adjustment mechanism 70 adjusts the back pressure appropriately. Accordingly, the pressing force of the movable scroll 44 is stabilized compared to a case using a mechanical structure such as an urging spring. This decreases leakage loss of working fluid caused by insufficient pressing force applied by the movable scroll 44 to the fixed scroll 46 and mechanical loss caused by excessive pressing force.

### Second Embodiment

A second embodiment of the present invention will now be described with reference to FIG. 3. Same or like reference numerals are given to components of the second embodiment that are the same as or like corresponding components of the first embodiment. Repeated description of these components is omitted or simplified herein. Unlike the first embodiment, the second embodiment does not have the inlet passage 54, which configures the inlet mechanism.

As illustrated in FIG. 3, a housing 72 of a complex fluid machine 71 has a tubular central housing member 73, a side plate 74, a front housing member 75, and a rear housing member 76. The side plate 74 is joined to the first end (the left end as viewed in FIG. 3) of the central housing member 73. The front housing member 75 is joined to the side plate 74. The rear housing member 76 is joined to the second end (the right end as viewed in FIG. 1A) of the central housing member 73. The support block 25 is fixed in the central housing member 73. The expanding portion 40 is accommodated in the space defined by the support block 25 and the rear housing member 76. The central housing member 73 receives the motor-generator 20.

A circular recess 74a, which is arranged around the drive shaft 21, is formed in the surface of the side plate 74 facing the front housing member 75. The front housing member 75 is joined to this surface to close the recess 74a. This forms a pump chamber 77 between the side plate 74 and the front housing member 75. The pump chamber 77 accommodates a drive gear 80 mounted on the drive shaft 21 and a driven gear (not shown). The drive gear 80 and the driven gear are meshed with each other. The pump chamber 77, the driven gear, and the drive gear 80 configure a gear pump 90. In the complex fluid machine 71 of the second embodiment, the gear pump 90, the motor-generator 20, and the expanding portion 40 are arranged sequentially in that order along the axial direction.

A suction passage 74b, which extends downward from the pump chamber 77, is formed in the side plate 74. The first end (the lower end as viewed in FIG. 3) of the suction passage 74b has an opening in the outer circumferential surface of the side plate 74. The second end of the suction passage 74b is connected to the pump chamber 77. A discharge passage 74c, which extends upward from the pump chamber 77, is formed in the side plate 74. The first end of the discharge passage 74c is connected to the pump chamber 77 and the second end of the discharge passage 74c has an opening in the outer circumferential surface of the side plate 74. The suction passage 74b communicates with the condenser 61 through the fourth passage 60e. The discharge passage 74c communicates with the heat absorber 62a of the heat exchanger 62 via the first passage 60a.

A first communication passage 82 extends in the side plate 74 and the central housing member 73. The first communication passage 82 is connected to the discharge passage 74c, which is a portion of the zone between the outlet side of the gear pump 90 and the inlet of the heat exchanger 62. A second communication passage 83 is formed in the support block 25. The first communication passage 82 communicates with the back pressure chamber 51 through the second communication passage 83. High pressure working fluid is introduced from the vicinity of the outlet of the gear pump 90 to the back pressure chamber 51 via the first communication passage 82 and the second communication passage 83. Accordingly, in the second embodiment, the first communication passage 82 and the second communication passage 83 configure an inlet mechanism for introducing working fluid from a high pressure zone between the outlet side of the gear pump 90 and the inlet of the heat exchanger 62 into the back pressure chamber 51. A non-illustrated filter is arranged in the first communication passage 82 or the second communication passage 83.

The second embodiment has the advantage described below, in addition to the same advantages as the advantages (1), (2), (4), (6), and (7) of the first embodiment.

(8) The complex fluid machine 71, which has the gear pump 90 and the expanding portion 40 integrally, is incorporated in the Rankine cycle apparatus 60. The gear pump 90, the motor-generator 20, and the expanding portion 40 are arranged sequentially in that order in the axial direction of the complex fluid machine 71. The first communication passage 82 is formed in the wall of the housing 72 and the second communication passage 83 extends in the support block 25. The gear pump 90 is connected to the back pressure chamber 51 through the first communication passage 82 and the second communication passage 83. As a result, despite the fact that the motor-generator 20 is arranged between the gear pump 90 and the expanding portion 40, the working fluid pumped out by the gear pump 90 is introduced into the back pressure chamber 51.

### Third Embodiment

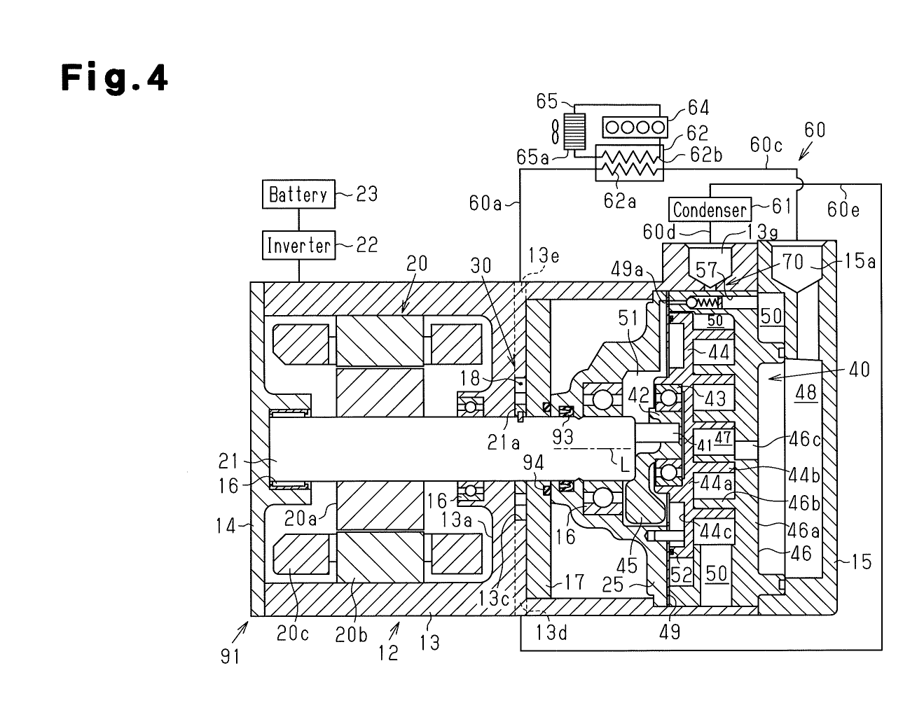

A third embodiment of the present invention will hereafter be described with reference to FIG. 4. Same or like reference numerals are given to components of the third embodiment that are the same as or like corresponding components of the first embodiment. Repeated description of these components is omitted or simplified herein. Unlike the first embodiment, the third embodiment is configured without the inlet passage 54, which configures the inlet mechanism.

As illustrated in FIG. 4, in a complex fluid machine 91, a shaft seal 93 formed by a V packing is mounted in the inner circumferential surface of the support block 25, instead of the shaft seal 28 of the first embodiment, which is formed by an O-ring. The shaft seal 93 seals the gap between the circumferential surface of the drive shaft 21 and the inner circumferential surface of the support block 25. A sealing member 94 formed by an O-ring is arranged in the gap between side plate 17 and the distal end of the support block 25 to encircle the drive shaft 21. The sealing member 94 seals the gap between the support block 25 and the side plate 17. In the third embodiment, the discharge passage 13e has an opening in the outer surface of the central housing member 13 without communicating with the retaining portion 53.

At the outlet side (the side corresponding to the discharge passage 13e) of the gear pump 30, the pressure in the vicinity of the drive shaft 21 is slightly higher than pressure intermediate between the low pressure at the side corresponding to the suction passage 13d and the high pressure at the side corresponding to the discharge passage 13e, and is higher than the pressure in the back pressure chamber 51. This urges the working fluid in the vicinity of the drive shaft 21 to flow from the gear pump 30 to the back pressure chamber 51. Specifically, the sealing force of the shaft seal 93 with respect to the drive shaft 21 is set to a moderate value so as to permit the working fluid to leak from the gear pump 30 to the back pressure chamber 51 along the drive shaft 21. This sends the working fluid from the vicinity of the drive shaft 21 in the gear pump 30 to the back pressure chamber 51 along the drive shaft 21. The working fluid increases the back pressure produced by the working fluid flowing into the back pressure chamber 51. Accordingly, in the third embodiment, the drive shaft 21 and the shaft seal 93 configure an inlet mechanism for introducing working fluid from a high pressure zone between the outlet side of the gear pump 30 and the inlet of the heat exchanger 62 into the back pressure chamber 51.

The third embodiment has the advantage described below, in addition to the same advantages as the advantages (1), (2), (3), (4), and (7) of the first embodiment.

(9) Working fluid is introduced from the vicinity of the drive shaft 21 in the gear pump 30 to the back pressure chamber 51 along the drive shaft 21. This simplifies the configuration of the inlet mechanism, compared to a case in which an inlet passage is formed in the housing 12 or the support block 25 to send high pressure working fluid from the gear pump 30 to the back pressure chamber 51.

### Fourth Embodiment

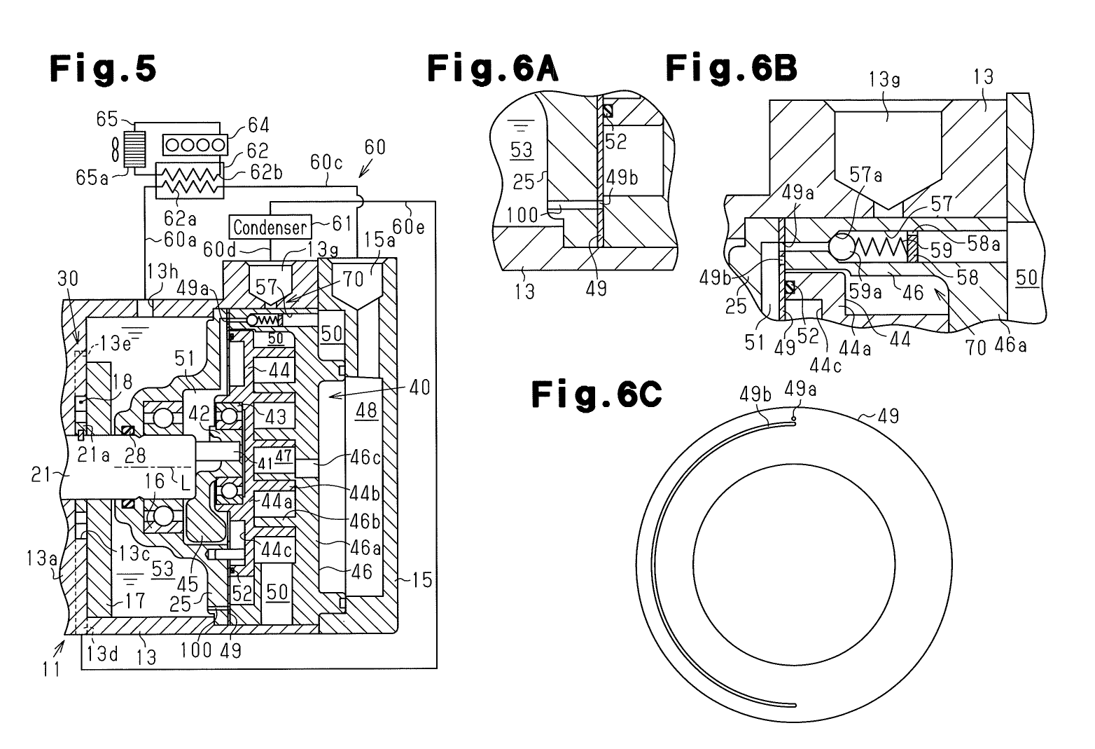

A fourth embodiment of the present invention will hereafter be described with reference to FIGS. 5 and 6A to 6C. Same or like reference numerals are given to components of the fourth embodiment that are the same as or like corresponding components of the complex fluid machine 11 of the first embodiment. Repeated description of these components is omitted or simplified herein. Unlike the first embodiment, the fourth embodiment does not include the inlet passage 54, which configures the inlet mechanism.

As illustrated in FIGS. 5 and 6A, a supply passage 100 extends through the support block 25 in the thickness direction (the axial direction) of the support block 25. A first end of the supply passage 100 has an opening facing the retaining portion 53. A second end of the supply passage 100 has an opening in the plate 49. With reference to FIGS. 6A and 6C, the plate 49 has a vaporization passage 49b, which is formed in the circumferential direction of the plate 49 to cover a half of the circumference of the plate 49 and extends through the plate 49 in the thickness direction (the axial direction) of the plate 49. The plate 49 is arranged between the support block 25 and the facing end surface of the fixed scroll 46. The facing surfaces thus seal the vaporization passage 49b.

A first end of the vaporization passage 49b is connected to the second end of the supply passage 100. A second end of the vaporization passage 49b is connected to the back pressure chamber 51. This allows communication between the retaining portion 53 and the back pressure chamber 51 through the supply passage 100 and the vaporization passage 49b. In the fourth embodiment, the supply passage 100 and the vaporization passage 49b configure an inlet passage serving as an inlet mechanism.

The high pressure working fluid (liquid) in the retaining portion 53 is restricted by the supply passage 100 through the pressure difference between the retaining portion 53 and the back pressure chamber 51 and provided to the vaporization passage 49b. The fixed scroll 46, which defines the vaporization passage 49b, is heated by the heated working fluid that has been expanded in the expanding portion 40. As a result, the working fluid in a liquid form flowing in the vaporization passage 49b is heated and vaporized through heat exchange between the working fluid and the fixed scroll 46 when flowing through the vaporization passage 49b. Accordingly, in the fourth embodiment, the fixed scroll 46 functions as a heat exchange portion that brings about heat exchange between the working fluid at the outlet side of the expanding portion 40 and the liquefied working fluid. The back pressure chamber 51 thus receives the vaporized working fluid.

The fourth embodiment has the advantages described below, in addition to the same advantages as the advantages (1) to (4) and (7) of the first embodiment.

(10) The liquefied working fluid in the retaining portion 53 is provided to the back pressure chamber 51 via the supply passage 100, which is formed in the support block 25, and the vaporization passage 49b, which is formed in the plate 49. The plate 49 is thermally bonded with the heated fixed scroll 46. This allows the working fluid to vaporize through the heat of the fixed scroll 46 when the working fluid flows in the vaporization passage 49b. The back pressure chamber 51 thus receives the vaporized working fluid. This decreases the resistance from the working fluid acting on the counterweight 45 and the eccentric shaft 41 when the counterweight 45 and the eccentric shaft 41 rotate in the back pressure chamber 51, compared to a case in which the back pressure chamber 51 receives liquefied working fluid. Loss of power in the motor-generator 20 is thus decreased.

(11) The plate 49 has the vaporization passage 49b, which extends in the circumferential direction of the plate 49 to cover a half of the circumference of the plate 49. When passing through the vaporization passage 49b, the working fluid presses the plate 49 against the movable scroll 44, thus pressing the movable scroll 44 against the fixed scroll 46. As a result, the movable scroll 44 is pressed against the fixed scroll 46 further intensely by the pressing force of the working fluid applied through the plate 49 in combination with the back pressure produced by the working fluid introduced into the back pressure chamber 51.

(12) The vaporization passage 49b is formed in the plate 49 to vaporize the liquefied working fluid retained in the retaining portion 53. Specifically, using the plate 49, the movable scroll 44 is pressed against the fixed scroll 46 through the back pressure. The material of the plate 49 may be selected to improve sliding performance of the plate 49 with respect to the end surface of the movable scroll 44. Since the plate 49 is a metal plate, the vaporization passage 49b is formed easily compared to a case in which the vaporization passage 49b is formed in the support block 25 or the fixed scroll 46.

(13) The working fluid in the liquid form in the retaining portion 53 is vaporized through heat exchange between the working fluid and the fixed scroll 46. The fixed scroll 46 is heated by the high temperature working fluid that has been heated by the engine 64. As a result, the working fluid is vaporized using the fixed scroll 46, which is a portion of the expanding portion 40, without employing an additional component.

### Fifth Embodiment

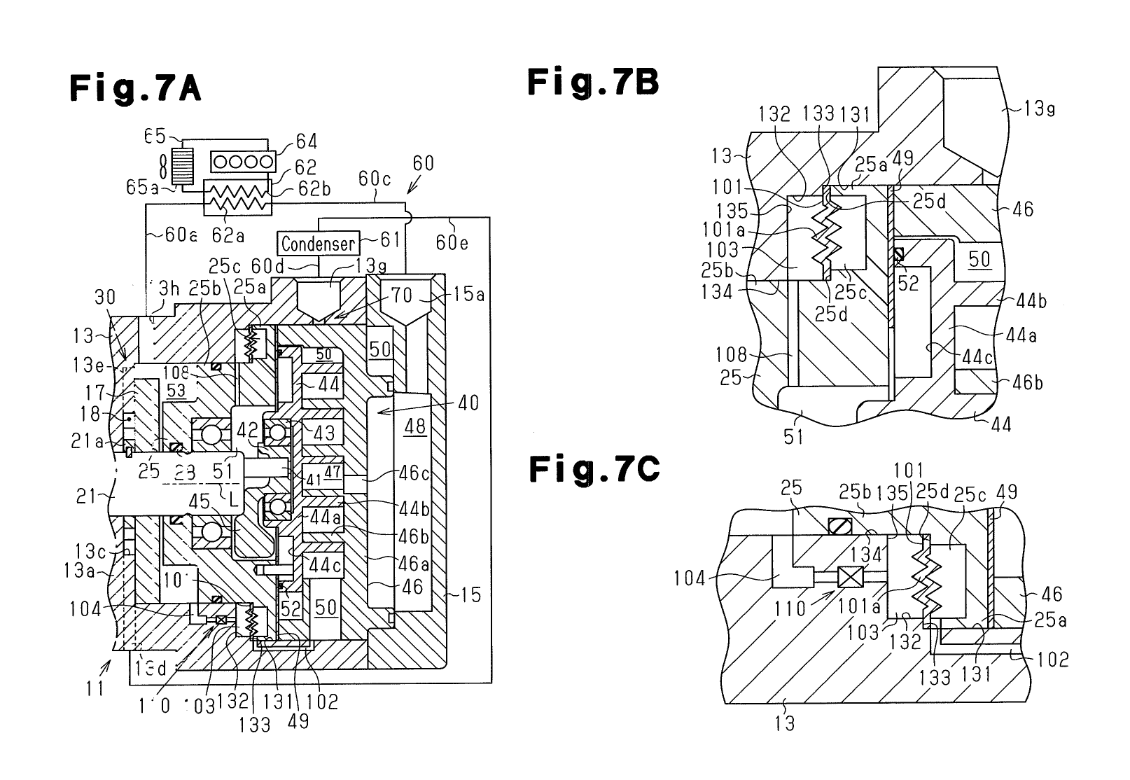

A fifth embodiment of the present invention will hereafter be described with reference to FIGS. 7A to 7C. Same or like reference numerals are given to components of the fifth embodiment that are the same as or like corresponding components of the first embodiment. Repeated description of these components is omitted or simplified herein. Unlike the first embodiment, the fifth embodiment is configured without the inlet passage 54, which configures the inlet mechanism.

As illustrated in FIGS. 7A and 7B, the support block 25 includes a disk-shaped first press-fitting portion 25a facing the plate 49 and a second press-fitting portion 25b, which is arranged closer to the gear pump 30 than the first press-fitting portion 25a and has a diameter smaller than the diameter of the first press-fitting portion 25a. An annular supply space 25c, to which working fluid is provided from the expanding portion 40, is formed in the end surface of the first press-fitting portion 25a opposite to the plate 49 a (at the side corresponding to the gear pump 30). A support surface 25d is formed at the opening end of the supply space 25c. With reference to FIG. 7C, a supply passage 102 connected to the supply space 25c and the discharge chamber 50 is formed in the central housing member 13. The supply space 25c receives expanded and heated working fluid through the supply passage 102.

As illustrated in FIGS. 7B and 7C, the central housing member 13 has a first wall portion 131 facing the outer circumferential surface of the first press-fitting portion 25a. The expanding portion 40 is arranged radially inward of the first wall portion 131. The central housing member 13 has a second wall portion 132, which is located closer to the gear pump 30 than the first wall portion 131 and has a diameter smaller than the diameter of the first wall portion 131. A first annular step 133 is formed in the inner circumferential surface of the central housing member 13 using the difference of the inner diameters between the first wall portion 131 and the second wall portion 132. The central housing member 13 also includes a third wall portion 134, which is arranged closer to the gear pump 30 than the second wall portion 132 and has a diameter smaller than the diameter of the second wall portion 132. A second annular step 135 is formed in the inner circumferential surface of the central housing member 13 using the difference of the inner diameters between the second wall portion 132 and the third wall portion 134.

The first press-fitting portion 25a is press-fitted in the first wall portion 131 and the second press-fitting portion 25b is press-fitted in the third wall portion 134. An outer peripheral portion of a heat exchange plate 101 serving as a heat exchange member of a heat exchange portion is arranged between the support surface 25d of the support block 25 and the first step 131 of the central housing member 13. A heat exchange fin 101a, which has a radially corrugated shape, is formed in the heat exchange plate 101.

An annular inlet space 103 is formed in the space defined by the outer circumferential surface of the second press-fitting portion 25b, the inner circumferential surface of the second wall portion 132, the second step 135, and the heat exchange plate 101. The inlet space 103 is located at a position opposing the supply space 25c of the support block 25.

With reference to FIG. 7C, a first inlet passage 104, which is connected to the retaining portion 53 and the inlet space 103, is formed in the central housing member 13. As illustrated in FIG. 7B, a second inlet passage 108, which is connected to the inlet space 103 and the back pressure chamber 51, is formed in the support block 25. The retaining portion 53 thus communicates with the back pressure chamber 51 through the first inlet passage 104, the inlet space 103, and the second inlet passage 108. Accordingly, in the fifth embodiment, the first inlet passage 104, the inlet space 103, and the second inlet passage 108 configure an inlet passage serving as an inlet mechanism.

An inlet side pressure difference adjustment mechanism 110 for adjusting the pressure difference between the back pressure chamber 51 and the discharge chamber 50 is formed in the first inlet passage 104. The inlet side pressure difference adjustment mechanism 110 is configured as an external control valve and includes a control valve arranged in the first inlet passage 104 and a controller signal-connected to the control valve. The pressure in the back pressure chamber 51 and the pressure in the discharge chamber 50 (the low pressure zone) are detected each by a pressure sensor. The controller adjusts the aforementioned pressure difference by adjusting the open degree of the control valve based on the pressure in the back pressure chamber 51 and the pressure in the discharge chamber 50, which are detected by the pressure sensors.

In this manner, the pressure difference between the back pressure chamber 51 and the discharge chamber 50 is adjusted to an appropriate value. In other words, when the pressure in the back pressure chamber 51 exceeds a predetermined value and an appropriate detection mechanism detects that the pressure difference is higher than a predetermined appropriate value, the inlet side pressure difference adjustment mechanism 110 increases the restriction amount of the first inlet passage 104, thus restricting the first inlet passage 104. This decreases the working fluid introduced into the back pressure chamber 51 to lower the pressure in the back pressure chamber 51, thus reducing the pressure difference.

In contrast, when the pressure in the back pressure chamber 51 drops below the predetermined value and the pressure difference decreases to a value less than the predetermined appropriate value, the inlet side pressure difference adjustment mechanism 110 decreases the restriction amount of the first inlet passage 104. This increases the working fluid discharged into the back pressure chamber 51 to raise the pressure in the back pressure chamber 51, thus increasing the pressure difference.

The high pressure working fluid (liquid) in the retaining portion 53 is restricted by the inlet side pressure difference adjustment mechanism 110 in the first inlet passage 104 and introduced into the inlet space 103. The supply space 25c, which faces the inlet space 103 with the heat exchange plate 101 arranged between the inlet space 103 and the supply space 25c, receives the heated working fluid that has been expanded by the expanding portion 40.

The heat exchange plate 101 is heated by the working fluid discharged into the supply space 25c. This heats and vaporizes the working fluid in the inlet space 103 through heat exchange between the working fluid and the heat exchange plate 101. In the fifth embodiment, the heat exchange plate 101 functions as a heat exchange member of a heat exchange portion. The vaporized working fluid is directed into the back pressure chamber 51.

The working fluid introduced into the back pressure chamber 51 varies the back pressure acting on the backside 44c. However, the inlet side pressure difference adjustment mechanism 110 adjusts the pressure difference between the back pressure chamber 51 and the discharge chamber 50 to the appropriate value. This adjusts the back pressure appropriately, thus stabilizing the pressing force of the movable scroll 44 applied to the fixed scroll 46.

The fifth embodiment has the advantages described below, in addition to the same advantages as the advantages (1) to (3) and (7) of the first embodiment.

(14) The liquefied working fluid in the retaining portion 53 is introduced into the back pressure chamber 51 via the first inlet passage 104, the inlet space 103, and the second inlet passage 108, which are formed in the central housing member 13. The inlet space 103 faces the supply space 25c with the heat exchange plate 101 arranged between the inlet space 103 and the supply space 25c. The supply space 25c receives the heated working fluid that has been expanded by the expanding portion 40. The heat exchange plate 101 is thus heated by the heated working fluid such that the working fluid in the inlet space 103 is vaporized. The vaporized working fluid then flows into the back pressure chamber 51, thus decreasing the resistance of the working fluid acting on the counterweight 45 and the eccentric shaft 41 when the counterweight 45 and the eccentric shaft 41 rotate in the back pressure chamber 51, compared to a case in which liquefied working fluid is introduced into the back pressure chamber 51. As a result, loss of the power generated by the motor-generator 20 is decreased.

(15) To vaporize working fluid, heat exchange is caused between the working fluid and expanded working fluid through the heat exchange plate 101. The heat exchange fin 101a, which improves the heat exchange rate, is formed in the heat exchange plate 101. Since the heat exchange plate 101 and the expanding portion 40 are independent from each other, the heat exchange area between the working fluid and the expanded working fluid is set as needed regardless of the design of the expanding portion 40. This ensures efficient vaporization of the working fluid.

The illustrated embodiments may be modified according to the forms described below.

In the fourth embodiment, the vaporization passage 49b is formed in the plate 49. However, the vaporization passage 49b may be formed in the support block 25 or the fixed scroll 46.

In the fourth embodiment, the width of the vaporization passage 49b may be changed as necessary. For example, the diameter of the end of the vaporization passage 49b facing the supply passage 100 may be reduced compared to the diameter of the opposite end, thus forming a restriction in the vaporization passage 49b.

As indicated by lines in FIG. 3 formed of a pair dashes alternating with a longer dash, a branched passage 95 may be formed in the first passage 60a in the vicinity of the inlet of the heat exchanger 62. In this case, the first passage 60a communicates with the second communication passage 83 through the branched passage 95. The high pressure working fluid that has been pumped out by the gear pump 90 but not yet been provided to the heat exchanger 62 is introduced into the back pressure chamber 51 via the first passage 60a, the branched passage 95, and the second communication passage 83. In this configuration, the branched passage 95 and the second communication passage 83 configure an inlet mechanism. An inlet side pressure difference adjustment mechanism for adjusting the pressure difference between the back pressure chamber 51 and the discharge chamber 50 may be formed in the branched passage 95 or the second communication passage 83.

In the first and second embodiments, the outlet side pressure difference adjustment mechanism 70 arranged in the outlet passage 57 adjusts the pressure difference between the back pressure chamber 51 and the discharge chamber 50 to the appropriate value. However, to adjust the pressure difference, the outlet side pressure difference adjustment mechanism 70 may be replaced by an inlet side pressure difference adjustment mechanism arranged in the inlet passage 54 in the first embodiment or an inlet side pressure difference adjustment mechanism formed in the first communication passage 82 or the second communication passage 83 in the second embodiment.

In the third embodiment, the drive shaft 21 and the shaft seal 93 configure the inlet mechanism. Instead, the shaft seal 93 may be an inlet side pressure difference adjustment mechanism capable of varying its contact force (sealing force) acting on the drive shaft 21 using the pressure difference. In these cases, the outlet side pressure difference adjustment mechanism 70 is omitted.

In the fourth embodiment, the outlet side pressure difference adjustment mechanism 70 arranged in the outlet passage 57 adjusts the pressure difference between the back pressure chamber 51 and the discharge chamber 50 to the appropriate value. However, the outlet side pressure difference adjustment mechanism 70 may be replaced by an inlet side pressure difference adjustment mechanism formed in the supply passage 100 to adjust the pressure difference between the back pressure chamber 51 and the discharge chamber 50.

In the fifth embodiment, the inlet side pressure difference adjustment mechanism 110 in the first inlet passage 104 adjusts the pressure difference between the back pressure chamber 51 and the discharge chamber 50 to the appropriate value. However, instead of the inlet side pressure difference adjustment mechanism 110, the outlet side pressure difference adjustment mechanism 70 arranged in the outlet passage 57, as in the first embodiment, may adjust the pressure difference.

In the illustrated embodiments, a circuit is configured by incorporating the complex fluid machine 11, 71, 91, which includes the motor-generator 20, the gear pump 30, 90, and the expanding portion 40 integrally, in the Rankine cycle apparatus 60. However, a motor-generator, a gear pump, and an expanding portion may be incorporated in a circuit independently from one another. Alternatively, a gear pump and a back pressure chamber in an expanding portion may be connected to each other through a pipe serving as an inlet mechanism. In this case, high pressure working fluid is pumped by the gear pump and provided into the back pressure chamber through the pipe.

In each of the illustrated embodiments, the housing of the complex fluid machine 11, 71, 91 accommodates the motor-generator 20, the gear pump 30, 90, the expanding portion 40, and the inlet mechanism. However, the housing of the complex fluid machine 11, 71, 91 may receive the motor-generator 20, the expanding portion 40, and the inlet mechanism, with the gear pump 30, 90 arranged outside the housing. This arrangement decreases the length of the complex fluid machine 11, 71, 91 compared to the case in which the gear pump 30, 90 is in the housing.

Each of the illustrated embodiments may employ a pump of any suitable type other than the gear pump 30, 90.

In the illustrated embodiments, the complex fluid machine 11, 71, 91 is employed only in the Rankine cycle apparatus 60. However, a compressing portion and a clutch mechanism may be formed integrally with the complex fluid machine 11, 71, 91 so that a refrigerating cycle is provided.

The fluid supplied from the exhaust heat source may be exhaust gas discharged from the engine 64.

The drive shaft 21 may project externally from the housing 12. In this case, the projecting end of the drive shaft 21 is connected to the engine 64 through a power transmission mechanism (a clutch, a pulley, or a belt).

The motor-generator 20 may be replaced by an alternator.

What is claimed is:

1. A Rankine cycle apparatus comprising a circuit, the circuit including:
a pump for pumping working fluid;
a heat exchanger for causing heat exchange between the working fluid received from the pump and fluid supplied from an exhaust heat source; and
an expanding portion that expands the working fluid that has been exposed to the heat exchange in the heat exchanger, thereby producing mechanical energy through the expansion, wherein
the expanding portion includes a fixed scroll, a movable scroll that orbits with respect to the fixed scroll as a drive shaft rotates, and a back pressure chamber arranged at the side corresponding to a backside of the movable scroll opposite to the surface facing the fixed scroll, and
the Rankine cycle apparatus further includes an inlet mechanism for introducing the working fluid from a high pressure zone to the back pressure chamber, thereby producing back pressure that presses the movable scroll against the fixed scroll along the axial direction of the drive shaft, the high pressure zone being a zone extending from an outlet side of the pump to an inlet of the heat exchanger.

2. The Rankine cycle apparatus according to claim 1, wherein the inlet mechanism is an inlet passage through which the high pressure zone communicates with the back pressure chamber, and a heat exchange portion for vaporizing the working fluid in a liquefied form is arranged in the inlet passage.

3. The Rankine cycle apparatus according to claim 2, wherein the heat exchange portion is a portion to which heat is transmitted from the working fluid that has been exposed to the heat exchange in the heat exchanger.

4. The Rankine cycle apparatus according to claim 2, wherein the heat exchange portion is a heat exchange member that causes heat exchange between the working fluid at an outlet side of the expanding portion and the working fluid in the liquefied form.

5. The Rankine cycle apparatus according to claim 1, wherein the inlet mechanism includes an inlet side pressure difference adjustment mechanism for adjusting, to an appropriate value, the pressure difference between the back pressure chamber and a low pressure zone having a pressure lower than the pressure in the back pressure chamber.

6. The Rankine cycle apparatus according to claim 1, wherein the back pressure chamber communicates with a low pressure zone the pressure of which is lower than the pressure in the back pressure chamber through an outlet passage, and an outlet side pressure difference adjustment mechanism is arranged in the outlet passage, the outlet side pressure difference adjustment mechanism adjusting the pressure difference between the back pressure chamber and the low pressure zone to an appropriate value.

7. The Rankine cycle apparatus according to claim 1, wherein the expanding portion and the inlet mechanism are located in a housing to configure a complex fluid machine.

8. The Rankine cycle apparatus according to claim 1, wherein the expanding portion and the pump are located in a housing to configure a complex fluid machine, and the inlet mechanism is located in the housing.

9. The Rankine cycle apparatus according to claim 8, wherein the expanding portion and the pump are arranged in parallel in the housing and adjacently located in the axial direction.

10. The Rankine cycle apparatus according to claim 1, wherein the inlet mechanism includes a filter.

11. A complex fluid machine incorporated in a Rankine cycle apparatus, the Rankine cycle apparatus having a circuit including a pump for pumping a working fluid, a heat exchanger for causing heat exchange between the working fluid received from the pump and fluid supplied from an exhaust heat source, and an expanding portion that expands the working fluid that has been exposed to the heat exchange in the heat exchanger, thereby producing mechanical energy through the expansion, the complex fluid machine comprising a housing for accommodating the expanding portion and the pump, wherein
the expanding portion includes a fixed scroll, a movable scroll that orbits with respect to the fixed scroll as a drive shaft rotates, and a back pressure chamber arranged at the side corresponding to a backside of the movable scroll opposite to the surface facing the fixed scroll, and
the complex fluid machine further includes an inlet mechanism for introducing the working fluid from a high pressure zone, which extends from an outlet side of the pump to an inlet of the heat exchanger, to the back pressure chamber, thereby producing back pressure that presses the movable scroll against the fixed scroll along the axial direction of the drive shaft.

12. The complex fluid machine according to claim 11, wherein the inlet mechanism is an inlet passage through which the high pressure zone communicates with the back pressure chamber, and a heat exchange portion for vaporizing the working fluid in a liquefied form is arranged in the inlet passage.

13. The complex fluid machine according to claim 12, wherein the heat exchange portion is a portion to which heat is transmitted from the working fluid that has been exposed to the heat exchange in the heat exchanger.

14. The complex fluid machine according to claim 12, wherein the heat exchange portion is a heat exchange member that causes heat exchange between the working fluid at an outlet side of the expanding portion and the working fluid in the liquefied form.

15. The complex fluid machine according to claim 11, wherein the inlet mechanism includes an inlet side pressure difference adjustment mechanism for adjusting, to an appropriate value, the pressure difference between the back pressure chamber and a low pressure zone having a pressure lower than the pressure in the back pressure chamber.

16. The complex fluid machine according to claim 11, wherein the back pressure chamber communicates with a low pressure zone the pressure of which is lower than the pressure in the back pressure chamber through an outlet passage, and an outlet side pressure difference adjustment mechanism is arranged in the outlet passage, the outlet side pressure difference adjustment mechanism adjusting the pressure difference between the back pressure chamber and the low pressure zone to an appropriate value.

17. The complex fluid machine according to claim 11, wherein the expanding portion and the inlet mechanism are located in the housing.

18. The complex fluid machine according to claim 11, wherein the expanding portion and the pump are located in the housing, and the inlet mechanism is located in the housing.

19. The complex fluid machine according to claim 18, wherein the expanding portion and the pump are arranged in parallel in the housing and adjacently located in the axial direction.
